(19) United States
(12) Patent Application Publication
(10) Pub. No.: US 2026/0048639 A1
(43) Pub. Date: Feb. 19, 2026

(54) Vehicle Control Apparatus and Method Thereof

(71) Applicants: Hyundai Motor Company, Seoul (KR); Kia Corporation, Seoul (KR)

(72) Inventors: Kug Hun Han, Hwaseong-si (KR); Ji Su Kim, Hwaseong-si (KR); Yu Jin Shim, Hwaseong-si (KR)

(21) Appl. No.: 19/049,654

(22) Filed: Feb. 10, 2025

(30) Foreign Application Priority Data
Aug. 13, 2024 (KR) 10-1024-0108581

(51) Int. Cl. B60H 1/00; B60N 2/56

(52) U.S. Cl. CPC B60H 1/00735; B60N 2/5628

(57) ABSTRACT

Disclosed is a vehicle control apparatus which includes memory and a processor. The memory may store program instructions for controlling at least one of: a heating element of a seat of a vehicle, or a ventilation motor of the seat of the vehicle. The processor may be configured to execute the program instructions to: identify a most recently used temperature setting of the seat before the heating element or the ventilation motor was powered off; and, based on at least one of an ignition state of the vehicle, whether a power source of the vehicle is remotely activated, or whether a battery of the vehicle is being charged, activate a control mode, most recently used in the vehicle, for controlling one of the heating element or the ventilation motor of the seat in one of: the most recently used temperature setting of the seat or a predetermined temperature setting.

### CROSS-REFERENCE TO RELATED APPLICATION

This application claims the benefit of priority to Korean Patent Application No. 10-2024-0108581, filed in the Korean Intellectual Property Office on Aug. 13, 2024, the entire contents of which are incorporated herein by reference.

### TECHNICAL FIELD

The present disclosure relates to a vehicle control apparatus and a method thereof, and more particularly relates to technologies for controlling a heating element or a ventilation of a car seat.

### BACKGROUND

In recent years, heated seats and ventilated seats have been more widely adopted in vehicles.

A heated seat may increase a temperature of the seat of the vehicle by means of a heating element (e.g., an electric wire) embedded in the seat of the vehicle. The warmed up seat may provide an extra bit of comfort to its occupant.

The ventilated seat may circulate air on or around the surface of the seat by means of a fan and an air vent, which are embedded in the seat of the vehicle. As the ventilated seat circulates the air on the surface of the seat, it may decrease the temperature of the seat, and thus provide a cool and comfortable sitting experience.

Heated seats and ventilated seats may be automatically controlled for safety and convenience of the user in the vehicle. For example, the temperature of the heated seat may be automatically regulated to prevent causing a burn on the user. Specifically, the heated seat or the ventilated seat may be adjusted according to multiple temperature settings.

The heated seat and the ventilated seat may be automatically controlled, and the heated seat or the ventilated seat may be automatically activated if the vehicle is ignition on.

### SUMMARY

The present disclosure has been made to solve the above-mentioned problems occurring in at least some implementations while advantages achieved by those implementations are maintained intact.

An aspect of the present disclosure provides a vehicle control apparatus for failing to operate a heating wire of a seat in the most recent temperature setting or failing to operate a ventilation motor of the seat in the most recent temperature setting if a user does not ride in a vehicle, for example, if the vehicle is remotely ignition on while the user does not ride in the vehicle or charging a battery of the vehicle while the user does not ride in the vehicle, to reduce unnecessary power consumption and a method thereof.

Another aspect of the present disclosure provides a vehicle control apparatus for correcting a temperature of a heating wire to the most recent temperature setting or adjusting (e.g., correcting) a rotational speed of a ventilation motor to the most recent temperature setting, based on an indoor temperature of a vehicle, an outdoor temperature of the vehicle, weather information, and user profile information, and a method thereof.

Another aspect of the present disclosure provides a vehicle control apparatus for controlling a heating element of a seat or a ventilation motor of the seat not to collide with an air conditioning system of a vehicle, a remote control system of the vehicle, or direct manipulation of a user to minimize inconvenience of the user due to a malfunction and a method thereof.

Another aspect of the present disclosure provides a vehicle control apparatus for controlling a heating element of a seat or a ventilation motor of the seat, which is previously loaded into a vehicle, to provide various users with a luxurious experience at a low cost and a method thereof.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a vehicle control apparatus may include: memory storing program instructions for controlling at least one of: a heating element of a seat of a vehicle, or a ventilation motor of the seat of the vehicle; and a processor configured to execute the program instructions to: identify a most recently used temperature setting, of a plurality of temperature settings, of the seat before the heating element or the ventilation motor was powered off; and based on at least one of an ignition state of the vehicle, whether a power source of the vehicle is remotely activated, or whether a battery of the vehicle is being charged, activate a control mode, most recently used in the vehicle, for controlling one of the heating element or the ventilation motor of the seat in one of: the most recently used temperature setting of the seat or a predetermined temperature setting. Each temperature setting of the plurality of temperature settings may correspond to one of: a respective temperature of the heating element or a respective rotational speed of the ventilation motor.

The processor may be configured to execute the program instructions to activate the control mode by: based on the ignition state of the vehicle transitioning from a deactivation state to an activation state, the power source of the vehicle not being remotely activated, and the battery of the vehicle not being charged, controlling the heating element or the ventilation motor of the seat in the most recently used temperature setting or the predetermined temperature setting.

The processor may be configured to execute the program instructions further to: determine not to activate the control mode, based on at least one of: the heating element or the ventilation motor of the seat being manipulated by a user, the heating element or the ventilation motor of the seat interworking with an air conditioning system for automatic control, the heating element or the ventilation motor of the seat operating in a specific temperature setting after the power source of the vehicle is remotely activated, or the heating element or the ventilation motor being powered off after the power source of the vehicle is remotely activated.

The processor may be configured to execute the program instructions further to: based on at least one of an indoor temperature of the vehicle, an outdoor temperature of the vehicle, or weather information, adjust a temperature, associated with the most recently used temperature setting, of the heating element or a rotational speed, associated with the most recently used temperature setting, of the ventilation motor.

The processor may be configured to execute the program instructions further to: adjust, based on profile information of a user of the vehicle, a temperature, associated with the most recently used temperature setting, of the heating element or a rotational speed, associated with the most recently used temperature setting, of the ventilation motor. The profile information may indicate at least one of: a gender of the user, an age of the user, or body information of the user.

The processor may be configured to execute the program instructions further to: adjust, based on the profile information being updated, the temperature, associated with the most recently used temperature setting, of the heating element or the rotational speed, associated with the most recently used temperature setting, of the ventilation motor.

The processor may be configured to execute the program instructions further to: activate, based on an idle stop and go (ISG) function, the control mode. The ISG function may enable the vehicle to, after the vehicle stops, temporarily turn off an engine of the vehicle and to, after the vehicle starts moving, turn on the engine.

The processor may be configured to execute the program instructions further to: based on the engine being temporarily turned off by the ISG function, perform at least one of: operating the heating element in a lowest temperature setting of the plurality of temperature settings, operating the ventilation motor in a temperature setting with a lowest rotational speed, powering off the heating element, or powering off the ventilation motor; and activate, based on the engine being turned on by the ISG function after the vehicle starts moving, the control mode.

The processor may be configured to execute the program instructions further to perform one of: setting, based on determining that the heating element of the seat is inoperable, the most recently used temperature setting to power off the heating element; or setting, based on determining that the ventilation motor is inoperable, the most recently used temperature setting to power off the ventilation motor.

The processor may be configured to execute the program instructions further to: store the most recently used temperature setting in the memory; and update, based on the heating element or the ventilation motor being powered off, the most recently used temperature setting.

The processor may be configured to execute the program instructions further to: power off, based on the ignition state of the vehicle being a deactivation state, the heating element and the ventilation motor.

The processor may be configured to execute the program instructions further to: determine whether to engage an automatic temperature adjustment function, which, based on the heating element operating for longer than a threshold time duration, switches the temperature setting of the heating element from a first temperature setting to a second temperature setting that is lower than the first temperature setting; and control, based on determining to engage the automatic temperature adjustment function before the heating element of the seat is powered off, the heating element of the seat to operate in the first temperature setting.

According to one or more example embodiments of the present disclosure, a method performed by an apparatus of a vehicle may include: identifying a most recently used temperature setting, of a plurality of temperature settings, of a seat of the vehicle before a heating element of the seat or a ventilation motor of the seat was powered off; and based on at least one of an ignition state of the vehicle, whether a power source of the vehicle is remotely activated, or whether a battery of the vehicle is being charged, activating a control mode, most recently used in the vehicle, for controlling one of the heating element or the ventilation motor of the seat in one of: the most recently used temperature setting of the seat or a predetermined temperature setting. Each temperature setting of the plurality of temperature settings may correspond to one of: a respective temperature of the heating element or a respective rotational speed of the ventilation motor.

Activating the control mode may include: based on the ignition state of the vehicle transitioning from a deactivation state to an activation state, the power source of the vehicle not being remotely activated, and the battery of the vehicle not being charged, controlling the heating element or the ventilation motor of the seat in the most recently used temperature setting or the predetermined temperature setting.

The method may further include: determining not to activate a second control mode, based on at least one of: the heating element or the ventilation motor of the seat being manipulated by a user, the heating element or the ventilation motor of the seat interworking with an air conditioning system for automatic control, the heating element or the ventilation motor of the seat operating in a specific temperature setting after the power source of the vehicle is remotely activated, or the heating element or the ventilation motor being powered off after the power source of the vehicle is remotely activated.

The method may further include: based on at least one of an indoor temperature of the vehicle, an outdoor temperature of the vehicle, or weather information, adjusting a temperature, associated with the most recently used temperature setting, of the heating element or a rotational speed, associated with the most recently used temperature setting, of the ventilation motor.

The method may further include: adjusting, based on profile information of a user of the vehicle, a temperature, associated with the most recently used temperature setting, of the heating element or a rotational speed, associated with the most recently used temperature setting, of the ventilation motor. The profile information may indicate at least one of: a gender of the user, an age of the user, or body information of the user.

The method may further include: adjusting, based on the profile information being updated, the temperature, associated with the most recently used temperature setting, of the heating element or the rotational speed, associated with the most recently used temperature setting, of the ventilation motor.

The method may further include: activating, based on an idle stop and go (ISG) function, the control mode. The ISG function may enable the vehicle to, after the vehicle stops, temporarily turn off an engine of the vehicle and to, after the vehicle starts moving, turn on the engine.

The method may further include: based on the engine being temporarily turned off by the ISG function, perform at least one of: operating the heating element in a lowest temperature setting of the plurality of temperature settings, operating the ventilation motor in a temperature setting with a lowest rotational speed, powering off the heating element, or powering off the ventilation motor; and activating, based on the engine being turned on by the ISG function after the vehicle starts moving, the control mode.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a vehicle control apparatus;

FIG. 2 is a block diagram illustrating an example of controlling a heating element of a seat or a ventilation motor of the seat based on state information of a vehicle or state information of the seat in a vehicle control apparatus;

FIG. 3 is a flowchart for describing a vehicle control apparatus or a vehicle control method;

FIG. 4 is a flowchart for describing an example of operating a heating element of a seat or a ventilation motor of the seat in a recent control mode with regard to a preferred control condition, in a vehicle control apparatus or a vehicle control method;

FIG. 5 is a flowchart for describing an example of changing a recent control mode based on a correction coefficient, in a vehicle control apparatus or a vehicle control method; and

FIG. 6 is a drawing illustrating a computing system associated with a vehicle control apparatus or a vehicle control method.

### DETAILED DESCRIPTION

Hereinafter, one or more example embodiments of the present disclosure will be described in detail with reference to the exemplary drawings. In adding the reference numerals to the components of each drawing, it should be noted that the identical component is designated by the identical numerals even when they are displayed on other drawings. In addition, a detailed description of well-known features or functions will be ruled out in order not to unnecessarily obscure the gist of the present disclosure.

In describing components of example embodiments of the present disclosure, the terms first, second, A, B, (a), (b), and the like may be used herein. These terms are only used to distinguish one component from another component, but do not limit the corresponding components irrespective of the order or priority of the corresponding components. Particularly, the expression “at least one of A, B, or C, or any combination thereof” may include “A”, “B”, or “C”, or “AB”, “BC”, “AC”, or “ABC”, which is a combination thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

In order to avoid causing of any injuries (e.g., a burn) to the occupant, the heated seat may be operated in the most recently used temperature setting of the heated seat before the vehicle's ignition was shut off, and/or the ventilated seat may be operated in the most recently set temperature setting of the ventilated seat before the vehicle ignition was shut off. At times, operating the heated seat and the ventilated seat in this manner may run counter to, interfere with, or interrupt the operations of other systems such as an air conditioning system of the vehicle.

Thus, the heating seat and the ventilation seat may be operated in the most recently used temperature setting before the vehicle was shut off, with a priority or a condition being set in relation to other various related functions of the vehicle.

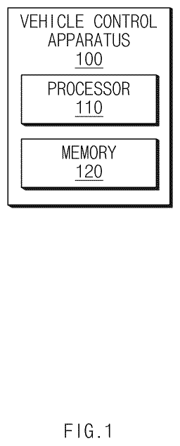

Hereinafter, one or more example embodiments of the present disclosure will be described in detail with reference to FIGS. 1 to 6.

FIG. 1 is a block diagram illustrating a vehicle control apparatus.

Referring to FIG. 1, a vehicle control apparatus 100 may be implemented in a vehicle. In this case, the vehicle control apparatus 100 may be integrally configured with control units in the vehicle or may be implemented as a separate device to be connected with the control units of the vehicle by a separate connection means.

The vehicle control apparatus 100 may include a processor 110 and a memory 120. The components of the vehicle control apparatus 100, which are shown in FIG. 1, are illustrative, and the present disclosure is not limited thereto. For example, the vehicle control apparatus 100 may further include components which are not shown in FIG. 1.

The memory 120 may store a command or data. For example, the memory 120 may store one instruction or two or more instructions, when executed by the processor 110, causing the vehicle control apparatus 100 to perform various operations.

For example, the memory 120 may store a program instruction in conjunction with a heating element of a seat of the vehicle or a ventilation motor of the seat of the vehicle.

The memory 120 may be implemented with the processor 110 as one chipset and may store various pieces of information associated with the vehicle control apparatus 100. For example, the memory 120 may store information about an operation history of the processor 110.

The memory 120 may include a non-volatile memory (e.g., a read only memory (ROM)) and a volatile memory (e.g., a random access memory (RAM)). For example, a heating stage in which the heating element of the seat lastly operates (e.g., the most recently used temperature setting) and a cooling stage in which the ventilation motor of the seat lastly operates (e.g., the most recently used temperature setting) may be stored in the memory 120. The heating state and/or the cooling stage may also be referred to as a temperature setting of the seat.

The processor 110 may identify at least one of a last heating stage which operates before the heating element of the seat is powered off among at least two heating stages divided according to a temperature of the heating element of the seat or a last cooling stage which operates before the ventilation motor of the seat is powered off among two cooling stages divided according to a rotational speed of the ventilation motor of the seat, or any combination thereof.

The heating element (e.g., a heating wire, a resistance wire, a resistance ribbon, a resistance coil, etc.) of the seat may operate based on at least two heating stages which have different temperatures. For example, the heating element of the seat may adjust a temperature for each stage within a range of specific temperatures. For example, the plurality of heating stages may include a first heating stage for maintaining the heating element of the seat at a low temperature, a second heating stage for maintaining the heating element of the seat at an intermediate temperature, and a third heating stage for maintaining the heating element of the seat at a high temperature.

If one or more termination conditions are met, the heating element of the seat may be powered off. For example, the heating element of the seat may be powered off if the ignition of the vehicle is turned off, the state of the ignition (IGN) of the vehicle is deactivated, a command to turn off the heating element of the seat is executed by a system, or the command to turn off the heating element of the seat is executed by manipulation of a user.

The processor 110 may identify the last heating stage which operates before the heating element is powered off. For example, if the heating element of the seat is able to operate in the first heating stage, the second heating stage, or the third heating stage and if the heating element operates in the second heating stage before the heating element of the seat is turned off, the processor 110 may identify the second heating stage as the last heating stage.

The ventilation motor of the seat may operate based on at least two cooling stages which have different rotational speeds. For example, the ventilation motor of the seat may adjust a rotational speed for each stage within a range of specific rotational speeds. At this time, the larger the rotational speed, the larger the temperature of the seat may be reduced to be. For example, the plurality of cooling stages may include a first cooling stage for rotating the ventilation motor at a first speed, a second cooling stage for rotating the ventilation motor at a second speed, and a third cooling stage for rotating the ventilation motor at a third speed. Herein, the third speed may be greater than the second speed, and the second speed may be greater than the first speed.

If one or more termination conditions are met, the ventilation motor of the seat may be powered off. For example, the ventilation motor of the seat may be powered off if the ignition of the vehicle is turned off, the state of the ignition (IGN) of the vehicle is deactivated, a command to turn off the ventilation motor of the seat is executed by the system, or the command to turn off the ventilation motor of the seat is executed by manipulation of the user.

The processor 110 may identify the last cooling stage which operates before the ventilation motor of the seat is powered off. For example, if the ventilation motor of the seat is able to operate in the first cooling stage, the second cooling stage, or the third cooling stage and if the heating element operates in the second cooling stage before the ventilation motor of the seat is turned off, the processor 110 may identify the second cooling stage as the last cooling stage.

The processor 110 may store at least one of the identified last heating stage or the identified last cooling stage, or any combination thereof in the memory 120. The processor 110 may store the identified last heating stage or the identified last cooling stage in the non-volatile memory.

For example, the processor 110 may monitor a heating stage which is operating and a cooling stage which is operating. If the heating element of the seat is powered off or the ventilation motor of the seat is powered off, the processor 110 may store a heating stage in which the heating element of the seat lastly operates or a cooling stage in which the ventilation motor of the seat lastly operates in the memory 120. The heating element of the seat or the ventilation motor of the seat may be powered off according to a load output condition. The load output condition may include if the vehicle is ignition off, the state of the ignition (IGN) of the vehicle is deactivated, the command to turn off the heating element of the seat is executed by the system, or the command to turn off the heating element of the seat is executed by the manipulation of the user.

For example, if a condition for storing the recent control mode is met, in a state in which the vehicle remotely operates or in a state in which the battery is charged, the processor 110 may store the heating stage in which the heating element of the storage lastly operates or the cooling stage in which the ventilation motor of the seat lastly operates in the memory 120. The condition for storing the recent control mode may include if the state of the IGN is deactivated, the state in which the vehicle remotely operates is deactivated, and the state in which the battery is charged changes to a state in which the battery is not charged.

The processor 110 may store only the heating stage in which the heating element of the seat lastly operates or the cooling stage in which the ventilation motor of the seat lastly operates in the memory 120, with regard to storage capacity of the memory 120. In other words, while monitoring the heating stage which is operating and the cooling stage which is operating, the processor 110 may store only the last heating stage which operates before the heating element of the seat is turned off or the last cooling stage which operates before the ventilation motor of the seat is turned off.

The processor 110 may update the last heating stage stored in the memory 120 whenever the heating element is powered off and may update the last cooling stage stored in the memory 120 whenever the ventilation motor is powered off.

The processor 110 may check whether the last heating stage and the last cooling stage are stored in the memory 120, via a situation in which the heating element or the ventilation motor is forcefully ended. The situation in which the heating element or the ventilation motor is forcefully ended may include a situation in which the battery is removed or a connector of a control unit associated with the heating element or the ventilation motor is removed.

The processor 110 may activate the recent control mode for controlling the heating element of the seat in the last heating stage or a predetermined heating stage or controlling the ventilation motor of the seat in the last cooling stage or a predetermined cooling stage, based on at least one of the state of the ignition (IGN) of the vehicle, whether the power source of the vehicle is remotely activated, or whether the battery of the vehicle is being charged, or any combination thereof.

For example, if the recent control mode is activated, the processor 110 may operate the heating element of the seat in the last heating stage. Furthermore, if the recent control mode is activated, the processor 110 may operate the ventilation motor of the seat in the last cooling stage.

For example, if the vehicle is ignition off in a state in which only the heating element of the seat operates in the second heating stage and the ventilation motor of the seat does not operate, before the vehicle is ignition off, the vehicle is ignition on again, and the recent control mode is activated, the processor 110 may operate only the heating element in the second heating stage.

For example, if the vehicle is ignition off in a state in which the heating element of the seat operates in the second heating stage and the ventilation motor of the seat operate in the first cooling stage, before the vehicle is ignition off, the vehicle is ignition on again, and the recent control mode is activated, the processor 110 may operate the heating element in the second heating stage and may operate the ventilation motor in the first cooling stage.

The state in which the power source of the vehicle is activated may include a state in which it is able to use a convenience device of the vehicle. For example, if the power source of the vehicle is remotely activated, the user may use the convenience device including a display, an air conditioning device, lighting, a seat, a wiper, and the like of the vehicle. For example, for an electric vehicle (EV), although the power source of the vehicle is activated, a power source for supplying power to the vehicle may fail to be activated.

If the recent control mode is activated, the processor 110 may operate the heating element of the seat in the predetermined heating stage or may operate the ventilation motor of the seat in the predetermined cooling stage.

For example, the predetermined heating stage or the predetermined cooling stage may be fixed to a specific stage. For example, if the predetermined heating stage is set to the second heating stage, the processor 110 may operate the heating element of the seat in the second heating stage whenever activating the recent control mode.

For example, the predetermined heating stage or the predetermined cooling stage may be differently set for each of various situations

For example, the predetermined heating stage or the predetermined cooling stage may be differently set according to the state of the ignition (IGN) of the vehicle, whether the power source of the vehicle is remotely activated, or whether the battery of the vehicle is being charged. Furthermore, the predetermined heating stage or the predetermined cooling stage may be differently set according to a user, weather, or the state of the vehicle.

The processor 110 may control the heating element of the seat in the last heating stage or the predetermined heating stage or may control the ventilation motor of the seat in the last cooling stage or the predetermined cooling stage, based on that the state of the IGN of the vehicle is activated, in a state in which the state of the IGN of the vehicle is deactivated (e.g., the ignition state of the vehicle transitioning from a deactivation state to an activation state), the power source of the vehicle is not remotely activated, and the battery of the vehicle is not being charged.

For example, the processor 110 may identify the state in which the state of the IGN of the vehicle is deactivated, the power source of the vehicle is not remotely activated, and the battery of the vehicle is not being charged. If the vehicle is an electric vehicle (EV), the state in which the battery of the vehicle is not being charged may include a state in which a high voltage battery for supplying power to the vehicle is not being charged. In other words, if the vehicle is the EV and the high voltage battery is not being charged, although a 12V low voltage battery is being charged, the processor 110 may determine the state in which the battery of the vehicle is not being charged.

The state of the IGN (also referred to as an ignition state) may include a state of IGN 1 (also referred to as a first ignition state), a state of IGN 2 (also referred to as a second ignition state), or a state of IGN 3 (also referred to as a third ignition state). The state of IGN 1 may include a state in which all control units of the vehicle are turned on and a state in which a starter motor of the vehicle is turned on. The state of IGN 2 may include a state in which an air conditioner, a heater, the heating element of the seat, the ventilation motor of the seat, or the like, which consumes much power, is powered on. The state of IGN 3 may include a state in which only a control unit associated with charging is powered on for an electric vehicle (EV) or a plug-in hybrid electric vehicle (PHEV).

For example, if the state of the IGN is deactivated, all of power sources except for a constant power source may be turned off. For example, the constant power source may include a power source necessary to open and close the door of the vehicle, a power source associated with an interior light of the vehicle, a power source associated with emergency lights, or the like.

For example, if the state in which the IGN of the vehicle is deactivated switches to the state in which the IGN of the vehicle is activated, in a state in which all of the condition in which the state of the IGN of the vehicle is deactivated, the condition in which the power source of the vehicle is not remotely activated and the condition in which the battery of the vehicle is not being charged are met. The state in which the IGN of the vehicle is activated may include a case in which the state of the IGN switches to the state of IGN 1, the state of IGN 2, or the state of IGN 3. As described above, the recent control mode may include a mode for controlling the heating element of the seat in the last heating stage or the predetermined heating stage or controlling the ventilation motor of the seat in the last cooling stage or the predetermined cooling stage.

The processor 110 may fail to activate the recent control mode, based on that the heating element of the seat or the ventilation motor of the seat is manipulated by the user, that the heating element of the seat or the ventilation motor of the seat interworks with the air conditioning system to be automatically controlled, or that the power source of the vehicle is remotely activated.

For example, if the user directly operates the heating element of the seat or directly operates the ventilation motor of the seat, the processor 110 may fail to activate the recent control mode. In this case, the heating element of the seat or the ventilation motor of the seat may operate in a stage manipulated by the user.

For example, if the heating element of the seat or the ventilation motor of the seat interworks with the air conditioning system of the vehicle to be automatically controlled, the processor 110 may fail to activate the recent control mode. For example, if the heating element of the seat is automatically controlled to a specific heating stage by the air conditioning system of the vehicle such that the indoor temperature of the vehicle reaches a specific temperature, the processor 110 may operate the heating element of the seat in a heating stage interworking with the air conditioning system of the vehicle.

For example, if the power source of the vehicle is remotely activated, the processor 110 may fail to activate the recent control mode. For example, the user may set the heating element of the seat or the ventilation motor of the seat to operate in the specific stage (e.g., a specific temperature setting), while remotely activating the power source of the vehicle (e.g., after the power source of the vehicle is remotely activated). In this case, the processor 110 may fail to operate (e.g., may determine not to operate) the heating element of the seat or the ventilation motor of the seat depending on the recent control mode and may operate the heating element of the seat or the ventilation motor of the seat in the specific stage which is remotely set.

For example, the user may power off the heating element of the seat or the ventilation motor of the seat, while remotely activating the power source of the vehicle. In this case, although the power source of the vehicle is remotely activated, the processor 110 may fail to operate the heating element of the seat or the ventilation motor of the seat depending on the recent control mode and may fail to operate the heating element of the seat or the ventilation motor of the seat.

If operating the heating element of the seat or the ventilation motor of the seat in the recent control mode, the processor 110 may consider a priority with another operation of the vehicle. If the other operation of the vehicle, which has a larger priority than the recent control mode, is identified, the processor 110 may fail to operate the heating element of the seat or the ventilation motor of the seat in the recent control mode.

For example, the other operations of the vehicle, which have large priorities, may include an input of audio video navigation telematics (AVNT) of the vehicle, speech recognition, an input by means of an application of a smartphone, or the like.

Furthermore, for example, the other operations of the vehicle, which have large priorities, may include an operation interworking with the air conditioning system to be automatically controlled or operations automatically controlled according to a temperature of the seat.

If storing the last heating stage of the heating element or the last cooling stage of the ventilation motor in the memory 120, the processor 110 may store an indoor temperature of the vehicle, an outdoor temperature of the vehicle, weather information, a gender of the user, an age of the user, or body information of the user.

The processor 110 may adjust (e.g., correct) a temperature of the heating element in the last heating stage or may adjust (e.g., correct) a rotational speed of the ventilation motor in the last cooling stage, based on at least one of the indoor temperature of the vehicle, the outdoor temperature of the vehicle, or the weather information, or any combination thereof.

For example, if the indoor temperature of the vehicle is lower than 5 degrees below zero, the processor 110 may operate the heating element of the seat in the last heating stage. If the indoor temperature of the vehicle is greater than 5 degrees below zero and is lower than 5 degrees above zero, the processor 110 may operate the heating element of the seat in a heating stage which is lower than the last heating stage by one stage. Furthermore, if the indoor temperature of the vehicle is greater than 5 degrees above zero, the processor 110 may fail to operate the heating element of the seat. The indoor temperature of the vehicle, which is criteria for adjusting (e.g., correcting) the temperature of the heating element, may fluctuate.

For example, if the indoor temperature of the vehicle is greater than 25 degrees above zero, the processor 110 may operate the ventilation motor of the seat in the last cooling stage. If the indoor temperature of the vehicle is lower than 20 degrees above zero and is greater than 10 degrees above zero, the processor 110 may operate the ventilation motor of the seat in a cooling stage which is lower than the last cooling stage by one stage. Furthermore, if the indoor temperature of the vehicle is lower than 10 degrees above zero, the processor 110 may fail to operate the ventilation motor of the seat. The indoor temperature of the vehicle, which is criteria for adjusting (e.g., correcting) the rotational speed of the ventilation motor, may fluctuate.

The processor 110 may compare an indoor temperature of the vehicle, an outdoor temperature, or weather information (hereinafter referred to as “past vehicle environment information”) at a time point when the last heating stage of the heating element or the last cooling stage of the ventilation motor is stored in the memory 120 with an indoor temperature of the vehicle, an outdoor temperature of the vehicle, or weather information (hereinafter referred to as “current vehicle environment information”) at a time point when the recent control mode is activated. The processor 110 may adjust (e.g., correct) a temperature of the heating element in the last heating stage or may adjust (e.g., correct) a rotational speed of the ventilation motor in the last cooling stage, depending on the result of comparing the pieces of vehicle environment information.

For example, if the indoor temperature included in the current vehicle environment information more changes than the indoor temperature included in the past vehicle environment information by a specific temperature value or more, the processor 110 may change the temperature of the heating element in the last heating stage. For example, the processor 110 may change the temperature of the heating element in the last heating stage from 40 degrees to 45 degrees. In a similar manner, the processor 110 may change the rotational speed of the ventilation motor in the last cooling stage stored as the recent control mode.

As another example, if the indoor temperature included in the current vehicle environment information more changes than the indoor temperature included in the past vehicle environment information by the specific temperature value or more, the processor 110 may change the last heating stage itself. For example, the processor 110 may change the last heating stage stored as the recent control mode from the second heating stage to the third heating stage. In a similar manner, the processor 110 may change the last cooling stage stored as the recent control mode.

The processor 110 may adjust (e.g., correct) the temperature of the heating element in the last heating stage or may adjust (e.g., correct) the rotational speed of the ventilation motor in the last cooling stage, based on profile information including at least one of the gender of the user, the age of the user, or the body information of the user, or any combination thereof.

The processor 110 may compare profile information (hereinafter referred to as “past profile information”) at a time point when the last heating stage of the heating element or the last cooling stage of the ventilation motor is stored in the memory 120 with profile information (hereinafter referred to as “current profile information”) at a time point when the recent control mode is activated. The processor 110 may adjust (e.g., correct) the temperature of the heating element in the last heating stage or may adjust (e.g., correct) the rotational speed of the ventilation motor in the last cooling stage, depending on the result of comparing the pieces of profile information.

For example, if the user is a female or an old man who is vulnerable to a cold temperature, the processor 110 may operate the heating element of the seat in a heating stage which is greater than the last heating stage by one stage. In a similar manner, if the user is the female or the old man who is vulnerable to the cold temperature, the processor 110 may operate the ventilation motor of the seat in a cooling stage which is lower than the last cooling stage by one stage.

For example, if the user is a male who is vulnerable to a heating temperature, the processor 110 may operate the heating element of the seat in a heating stage which is lower than the last heating stage by one stage. In a similar manner, if the user is the male who is vulnerable to the heating temperature, the processor 110 may operate the ventilation motor of the seat in a cooling stage which is greater than the last cooling stage by one stage.

The processor 110 may adjust (e.g., correct) the temperature of the heating element in the last heating stage or may adjust (e.g., correct) the rotational speed of the ventilation motor in the last cooling stage, based on considering both the “vehicle environment information” including the indoor temperature of the vehicle, the outdoor temperature, or the weather information and the “profile information” including the gender of the user, the age of the user, and the body information of the user.

For example, the processor 110 may reflect the profile information in setting the indoor temperature of the vehicle, which is criteria for adjusting (e.g., correcting) the temperature of the heating element. Similarly, the processor 110 may reflect the profile information in setting the indoor temperature of the vehicle, which is criteria for adjusting (e.g., correcting) the rotational speed of the ventilation motor.

The processor 110 may determine the predetermined heating stage or the predetermined cooling stage, based on the indoor temperature of the vehicle, the outdoor temperature of the vehicle, the weather information, the gender of the user, the age of the user, or the body information of the user.

The processor 110 may update the profile information based on that the information included in the profile information is changed.

For example, the profile information may be changed by an input of the user. Furthermore, the profile information may be changed by information detected by a sensor. If the information included in the profile information is changed, the processor 110 may update the profile information stored in the memory 120.

The processor 110 may adjust (e.g., correct) the temperature of the heating element in the last heating stage or may adjust (e.g., correct) the rotational speed of the ventilation motor in the last cooling stage, depending on the updated profile information. Furthermore, the processor 110 may change the last heating stage depending on the updated profile information or may change the last cooling stage depending on the updated profile information.

The processor 110 may activate the recent control mode, based on an idle stop and go (ISG) function of temporarily turning off the engine if the vehicle stops and turning on the engine again if the vehicle starts to drive in the state in which the engine is turned off or a specified driving condition is satisfied.

If the engine is temporarily turned off by the ISG function, the processor 110 may operate the heating element in a heating stage with a lowest temperature or may operate the ventilation motor in a cooling stage with a lowest rotational speed. For example, if the engine is temporarily turned off by the ISG function while the heating element of the seat is operating in the third heating stage with a highest temperature of the heating element, the processor 110 may operate the heating element of the seat in the first heating stage with a lowest temperature of the heating element of the seat.

If the engine is temporarily turned off by the ISG function, the processor 110 may power off the heating element or the ventilation motor. For example, if the engine is temporarily turned off by the ISG function, the processor 110 may power off the heating element or the ventilation motor such that the interior of the vehicle is kept quiet. At this time, brightness of an indicator for displaying a heating stage of the heating element and brightness of an indicator for displaying a cooling stage of the ventilation motor may also be reduced.

If the engine is temporarily turned off by the ISG function, the processor 110 may store the last heating stage of the heating element or the last cooling stage of the ventilation motor. The processor 110 may store the last heating stage of the heating element or the last cooling stage of the ventilation motor as the recent control mode.

If the engine is turned on again by the ISG function, the processor 110 may activate the recent control mode. For example, if the engine is turned on again by the ISG function, the processor 110 may operate the heating element again in the last heating stage and may operate the ventilation motor again in the last cooling stage.

If a heating stage or a cooling stage, which operates based on the ISG function, is separately set and if the engine is turned on again by the ISG function, |the processor 110 may fail to activate the recent control mode. In this case, if the engine is turned on again by the ISG function, the processor 110 may operate the heating element in the separately set heating stage or may operate the ventilation motor in the separately set cooling stage.

The processor 110 may identify that the heating element of the seat or the ventilation motor of the seat does not normally operate (e.g., the heating element or the ventilation motor is inoperable). For example, if a circuit associated with the heating element or the ventilation motor is short-circuited, the heating element or the ventilation motor may fail to normally operate. Furthermore, if an error in software occurs, the heating element or the ventilation motor may fail to normally operate.

The processor 110 may set the last heating stage to a stage in which the heating element is powered off, based on that the heating element of the seat does not normally operate. For example, if identifying that the heating element of the seat does not normally operate, although the recent control mode is activated, the processor 110 may fail to power on the heating element.

The processor 110 may set the last cooling stage to a stage in which the ventilation motor is powered off, based on that the ventilation motor of the seat does not normally operate. For example, if identifying that the ventilation motor of the seat does not normally operate, although the recent control mode is activated, the processor 110 may fail to power on the ventilation motor of the seat.

As a result, the processor 110 may reduce power consumed by the heating element of the seat (or the ventilation motor of the seat) to dial down or disable the heating element (or the ventilation motor), thereby preventing these functions from interfering with, adversely affecting, or interrupting another function of the vehicle.

The processor 110 may power off both the heating element and the ventilation motor, based on that the state of the IGN of the vehicle is deactivated. As described above, the case in which the state of the IGN is deactivated may include a state in which all of power sources except for the constant power source are turned off. For example, the constant power source may include a power source necessary to open or close the door of the vehicle, a power source associated with an interior light of the vehicle, a power source associated with emergency lights, or the like.

If both the heating element and the ventilation motor are powered off as the state of the IGN of the vehicle is deactivated, the processor 110 may store the last heating stage which operates before the heating element of the seat is turned off or the last cooling stage which operates before the ventilation motor of the seat is turned off in the memory 120.

The processor 110 may determine whether to operate (e.g., engage) an automatic temperature adjustment feature (also referred to as an auto down function), which may lower a temperature setting of the heating element after a threshold time duration elapses. For example, after the heating element operates for longer than the threshold time duration, the automatic temperature adjustment feature may switch the temperature setting of the heating element of the seat from a first temperature setting to a second temperature setting that is lower than the first temperature setting.

For example, if the heating element of the seat continues operating at a high temperature, the user may have a risk of suffering an injury such as a burn. Thus, a heating stage in the heating element of the seat automatically operates as a predetermined time elapses after the heating element of the seat operates may be lowered (e.g., from a first temperature setting to a second temperature setting lower than the first temperature setting).

For example, if 30 minutes elapse after the heating element of the seat operates in the third heating stage with a highest temperature, the heating element of the seat may operate in the second heating stage by the automatic temperature adjustment function. If 50 minutes elapse after the heating element of the seat operates in the second heating stage, the heating element of the seat may operate in the first heating stage by the automatic temperature adjustment function.

The automatic temperature adjustment function may also be applied to the ventilation motor. For example, a cooling stage in which the ventilation motor of the seat automatically operates as the predetermined time elapses after the ventilation motor of the seat operates may be lowered.

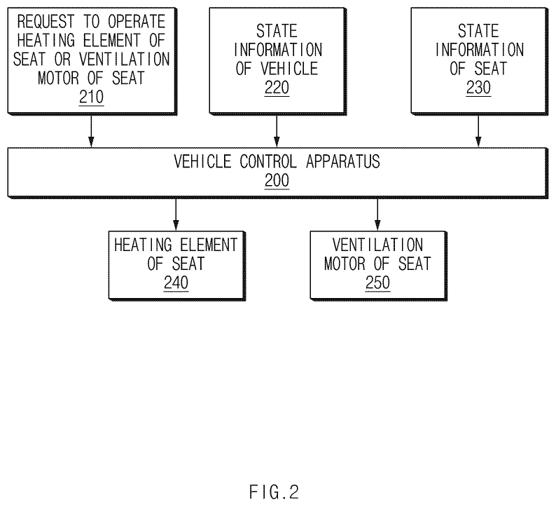

FIG. 2 is a block diagram illustrating an example of controlling a heating element of a seat or a ventilation motor of the seat based on state information of a vehicle or state information of the seat in a vehicle control apparatus.

A vehicle control apparatus 200 may receive a request 210 to operate the heating element of the seat or the ventilation motor of the seat. For example, the vehicle control apparatus 200 may receive the request 210 to operate the heating element of the seat or the ventilation motor of the seat, via an input of audio video navigation telematics (AVNT) of a vehicle, speech recognition using a microphone of the vehicle, an input using an application of a smartphone, a physical button provided in the vehicle, or the like.

The vehicle control apparatus 200 may obtain state information 220 of the vehicle. For example, the state information 220 of the vehicle may include an indoor temperature of the vehicle, an outdoor temperature of the vehicle, a start state of the vehicle, a charging state of the battery of the vehicle, a state of charge (SOC) of the battery, a state of health (SOH) of the battery, profile information of a user, a position of the vehicle, weather information based on the position of the vehicle, or the like.

The vehicle control apparatus 200 may obtain the state information 220 of the vehicle by means of a sensor of the vehicle and may obtain the state information 220 of the vehicle from an external server.

The vehicle control apparatus 200 may obtain state information 230 of the seat. For example, the state information 230 of the seat may include information about whether the user rides, information about an image obtained by capturing the user, information about operation of a heating element of the seat, information about operation of a ventilation motor of the seat, information about a convenience function of the seat, or the like.

The vehicle control apparatus 200 may control a heating element 240 of the seat. The vehicle control apparatus 200 may control a device which drives the heating element 240. For example, the vehicle control apparatus 200 may adjust a temperature of the heating element 240 of the seat. In detail, the vehicle control apparatus 200 may adjust the temperature of the heating element 240 of the seat depending on a plurality of heating stages.

The vehicle control apparatus 200 may control a ventilation motor 250 of the seat. The vehicle control apparatus 200 may control a device which drives the ventilation motor 250. For example, the vehicle control apparatus 200 may adjust a rotational speed of the ventilation motor 250 of the seat. In detail, the vehicle control apparatus 200 may adjust the rotational speed of the ventilation motor 250 of the seat depending on a plurality of cooling stages.

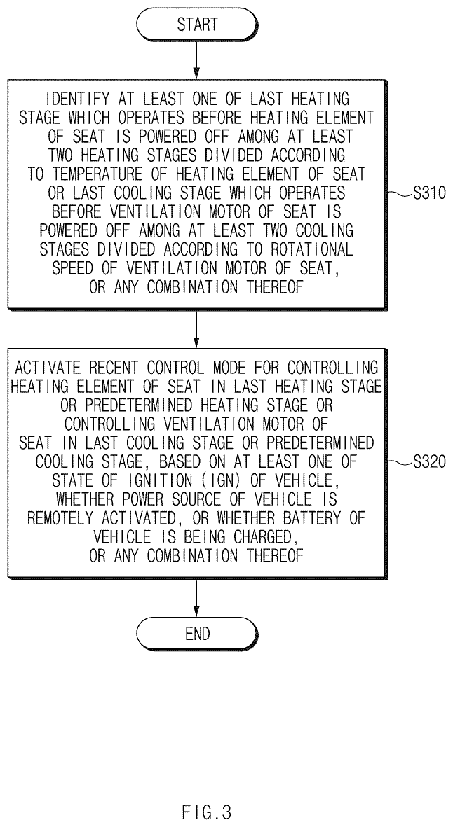

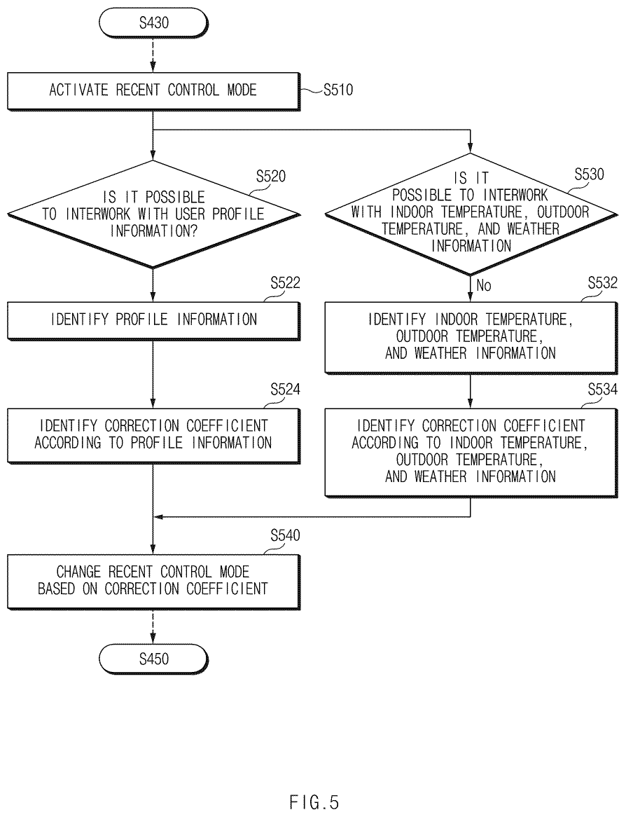

Hereinafter, a description will be given in detail of a vehicle control method with reference to FIGS. 3 and 5. Each operation in FIGS. 3 to 5 may be understood as being performed by the processor 110 of the vehicle control apparatus 100 of FIG. 1, which is described above.

FIG. 3 is a flowchart for describing a vehicle control apparatus or a vehicle control method.

In S310, a processor of the vehicle control apparatus may identify at least one of a last heating stage which operates before a heating element of a seat is powered off among at least two heating stages divided according to a temperature of the heating element of the seat or a last cooling stage which operates before a ventilation motor of the seat is powered off among at least two cooling stages divided according to a rotational speed of the ventilation motor of the seat, or any combination thereof.

In S320, the processor of the vehicle control apparatus may activate a recent control mode for controlling the heating element of the seat in the last heating stage or a predetermined heating stage or controlling the ventilation motor of the seat in the last cooling stage or a predetermined cooling stage, based on at least one of a state of an ignition (IGN) of a vehicle, whether a power source of the vehicle is remotely activated, or whether a battery of the vehicle is being charged, or any combination thereof.

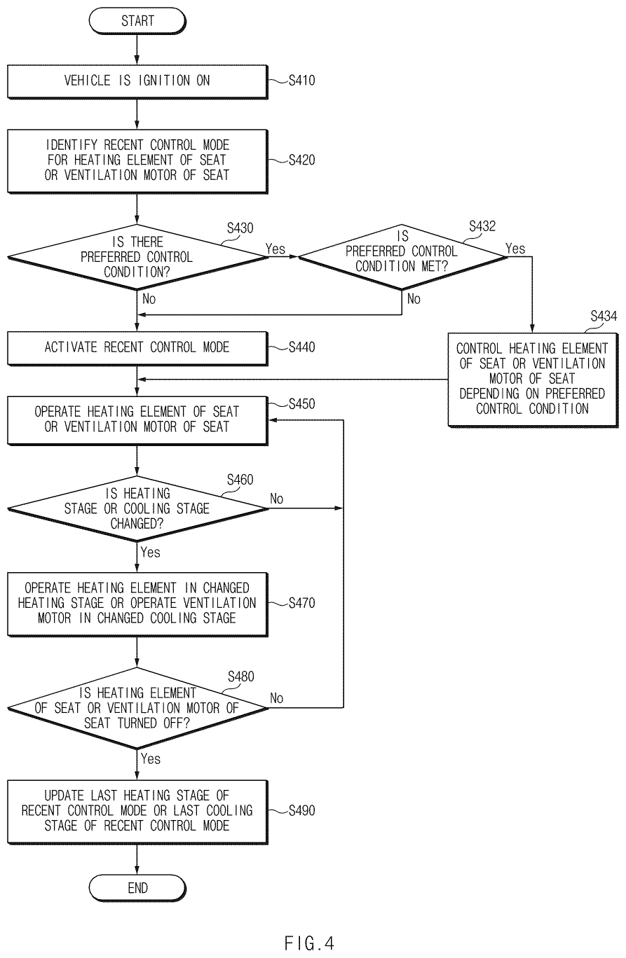

FIG. 4 is a flowchart for describing an example of operating a heating element of a seat or a ventilation motor of the seat in a recent control mode with regard to a preferred control condition, in a vehicle control apparatus or a vehicle control method.

In S410, the vehicle control apparatus may identify a situation in which the vehicle is ignition on. The situation in which the vehicle is ignition on may include a situation in which a state of an ignition (IGN) is activated.

In S420, the vehicle control apparatus may identify a recent control mode for a heating element of a seat or a ventilation motor of the seat. For example, the vehicle control apparatus may fetch the recent control mode stored in a memory. A heating stage in which the heating element of the seat lastly operates and a cooling stage in which the ventilation motor of the seat lastly operates may be stored in the memory.

In S430, the vehicle control apparatus may determine whether there is a preferred control condition. The preferred control condition may include another operation of a vehicle, which has a larger priority than the recent control mode. In detail, the preferred control condition may include an operation by an input of audio video navigation telematics (AVNT) of the vehicle, speech recognition, or an input by means of an application of a smartphone, an operation automatically controlled as the heating element or the ventilation motor of the seat interworks with an air conditioning system, or operations in which the heating element or the ventilation motor of the seat is automatically controlled according to a temperature of the seat.

If there is the preferred control condition, in S432, the vehicle control apparatus may determine whether the preferred control condition is met. For example, if a user operates the heating element of the seat in a specific heating stage using the AVNT of the vehicle, the vehicle control apparatus may determine that the preferred control condition is met.

If determining that the preferred control condition is met, in S434, the vehicle control apparatus may control the heating element of the seat or the ventilation motor of the seat depending on the preferred control condition. For example, if the user operates the heating element of the seat in a second heating stage using the AVNT of the vehicle, the vehicle control apparatus may operate the heating element of the seat in the second heating stage.

If determining that there is no preferred control condition or determining that the preferred control condition is not met, in S440, the vehicle control apparatus may activate the recent control mode.

In S450, the vehicle control apparatus may operate the heating element of the seat or the ventilation motor of the seat.

For example, if activating the recent control mode, the vehicle control apparatus may operate the heating element of the seat in a last heating stage according to the recent control mode or may operate the ventilation motor in a last cooling stage according to the recent control mode.

For another example, if operating the heating element of the seat or the ventilation motor of the seat depending on the preferred control condition, the vehicle control apparatus may operate the heating element of the seat in a heating stage according to the preferred control condition or may operate the ventilation motor in a cooling stage according to the preferred control condition.

In S460, the vehicle control apparatus may determine whether the heating stage or the cooling stage is changed. For example, the heating stage or the cooling stage may be changed by manipulation of the user. For another example, the heating stage or the cooling stage may be changed according to interworking with an air conditioning system of the vehicle.

If the heating stage or the cooling stage is changed, in S470, the vehicle control apparatus may operate the heating element in the changed heating stage or may operate the ventilation motor in the changed cooling stage.

In S480, the vehicle control apparatus may determine whether the heating element of the seat or the ventilation motor of the seat is turned off. For example, if the vehicle is ignition off, the state of the ignition (IGN) of the vehicle is deactivated, a command to turn off the heating element or the ventilation motor is executed by a system, or the command to turn off the heating element or the ventilation motor is executed by manipulation of the user, the heating element of the seat or the ventilation motor of the seat may be powered off.

If the heating element of the seat or the ventilation motor of the seat is turned off, in S490, the vehicle control apparatus may update a last heating stage of the recent control mode or a last cooling stage of the recent control mode. For example, if the heating stage is changed before the heating element of the seat is turned off, the vehicle control apparatus may update the changed heating stage to the last heating stage. The vehicle control apparatus may store the last heating stage or the last cooling stage in the memory.

Referring to FIG. 4, by considering the preferred control condition, the vehicle control apparatus may fail to collide with various functions of the vehicle although operating the heating element or the ventilation motor in the recent control mode.

FIG. 5 is a flowchart for describing an example of changing a recent control mode based on an adjustment coefficient (e.g., a correction coefficient), in a vehicle control apparatus or a vehicle control method.

The flowchart of FIG. 5 may illustrate an example of operations performed in S440 for activating a recent control mode of FIG. 4.

In S510, the vehicle control apparatus may activate the recent control mode.

If activating the recent control mode, in S520, the vehicle control apparatus may determine whether it is possible to interwork with user profile information. For example, the user profile information may fail to interwork depending on a vehicle type, and the user profile information may fail to interwork depending on that there is no profile information.

If the user profile information interworks, in S522, the vehicle control apparatus may identify profile information. For example, at least one of a gender of a user, an age of the user, or body information of the user, or any combination thereof may be included in the profile information.

In S524, the vehicle control apparatus may identify an adjustment coefficient (e.g., a correction coefficient) according to the profile information. For example, the adjustment coefficient (e.g., the correction coefficient) may include a weight for adjusting (e.g., correcting) a temperature of a heating element or a heating stage depending on the profile information. Furthermore, the adjustment coefficient (e.g., the correction coefficient) may include a weight for adjusting (e.g., correcting) a rotational speed of a ventilation motor or a cooling stage depending on the profile information.

In S540, the vehicle control apparatus may change the recent control mode based on the adjustment coefficient (e.g., the correction coefficient) identified according to the profile information. For example, the vehicle control apparatus may adjust (e.g., correct) a temperature of the heating element in a last heating stage or may adjust (e.g., correct) a rotational speed of the ventilation motor in a last cooling stage, based on the profile information.

For example, if the user is a female or an old man who is vulnerable to a cold temperature, the adjustment coefficient (e.g., the correction coefficient) may be identified as a weight for increasing the last heating stage by one stage. In this case, if the user is the female or the old man who is vulnerable to the cold temperature, the vehicle control apparatus may operate a heating element of a seat in a heating stage which is greater than the last heating stage by one stage.

If activating the recent control mode, in S530, the vehicle control apparatus may determine whether it is possible to interwork with an indoor temperature, an outdoor temperature, and weather information.

If interworking with the indoor temperature, the outdoor temperature, and the weather information, in S532, the vehicle control apparatus may identify the indoor temperature, the outdoor temperature, and the weather information.

In S534, the vehicle control apparatus may identify an adjustment coefficient (e.g., a correction coefficient) according to the indoor temperature, the outdoor temperature, and the weather information. For example, the adjustment coefficient (e.g., the correction coefficient) may include a weight for adjusting (e.g., correcting) a temperature of the heating element or a heating stage depending on the indoor temperature, the outdoor temperature, and the weather information. Furthermore, the adjustment coefficient (e.g., the correction coefficient) may include a weight for adjusting (e.g., correcting) a rotational speed of the ventilation motor or a cooling stage depending on the indoor temperature, the outdoor temperature, and the weather information.

In S540, the vehicle control apparatus may change the recent control mode based on the adjustment coefficient (e.g., the correction coefficient) identified according to the indoor temperature, the outdoor temperature, and the weather information. For example, the vehicle control apparatus may adjust (e.g., correct) a temperature of the heating element in the last heating stage or may adjust (e.g., correct) a rotational speed of the ventilation motor in the last cooling stage, based on the indoor temperature, the outdoor temperature, and the weather information.

Referring to FIG. 5, the vehicle control apparatus may fail to uniformly apply the recent control mode and may adjust (e.g., correct) the recent control mode based on the user profile information, the indoor temperature, the outdoor temperature, or the weather information, thus improving convenience of the user and reducing unnecessary energy consumption.

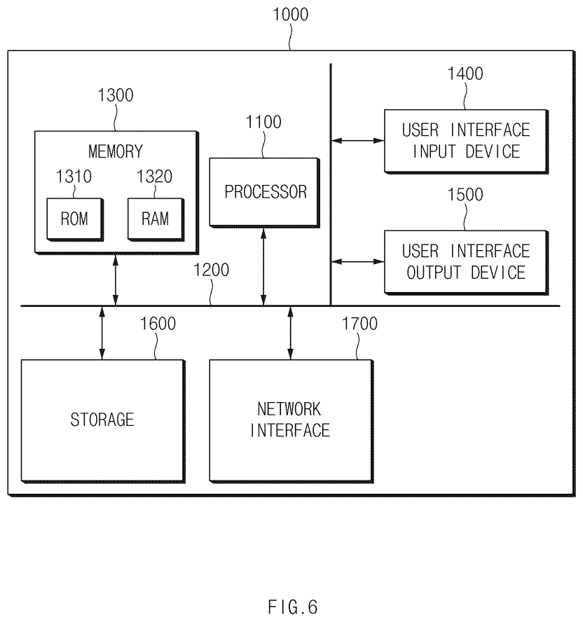

FIG. 6 is a drawing illustrating a computing system associated with a vehicle control apparatus or a vehicle control method.

Referring to FIG. 6, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described herein may be directly implemented with hardware, software, or a combination of hardware and software, which is executed by the processor 1100. The software may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

According to an aspect of the present disclosure, a vehicle control apparatus may include a memory storing a program instruction in conjunction with a heating wire of a seat of a vehicle or a ventilation motor of the seat of the vehicle and a processor that executes the program instruction. The processor may identify at least one of a last heating stage which operates before the heating wire of the seat is powered off among at least two heating stages divided according to a temperature of the heating wire of the seat or a last cooling stage which operates before the ventilation motor of the seat is powered off among at least two cooling stages divided according to a rotational speed of the ventilation motor of the seat, or any combination thereof and may activate a recent control mode for controlling the heating wire of the seat in the last heating stage or a predetermined heating stage or controlling the ventilation motor of the seat in the last cooling stage or a predetermined cooling stage, based on at least one of a state of an ignition (IGN) of the vehicle, whether a power source of the vehicle is remotely activated, or whether a battery of the vehicle is being charged, or any combination thereof.

The processor may control the heating wire of the seat in the last heating stage or the predetermined heating stage or may control the ventilation motor of the seat in the last cooling stage or the predetermined cooling stage, based on that the state of the IGN of the vehicle is activated, in a state in which the state of the IGN of the vehicle is deactivated, the power source of the vehicle is not remotely activated, and the battery of the vehicle is not being charged.

The processor may fail to activate the recent control mode, based on that the heating wire of the seat or the ventilation motor of the seat is manipulated by a user, the heating wire of the seat or the ventilation motor of the seat interworks with an air conditioning system to be automatically controlled, the heating wire of the seat or the ventilation motor of the seat operates in a specific stage while the power source of the vehicle is remotely activated, or the heating wire or the ventilation motor is powered off while the power source of the vehicle is remotely activated.

The processor may correct a temperature of the heating wire in the last heating stage or may correct a rotational speed of the ventilation motor in the last cooling stage, based on at least one of an indoor temperature of the vehicle, an outdoor temperature of the vehicle, or weather information, or any combination thereof.

The processor may correct a temperature of the heating wire in the last heating stage or may correct a rotational speed of the ventilation motor in the last cooling stage, based on profile information including at least one of a gender of a user, an age of the user, or body information of the user, or any combination thereof.

The processor may update the profile information based on that information included in the profile information is changed and may correct the temperature of the heating wire in the last heating stage or may correct the rotational speed of the ventilation motor in the last cooling stage, based on the updated profile information.

The processor may activate the recent control mode, based on an idle stop and go (ISG) function of temporarily turning off an engine if the vehicle stops and turning on the engine again if the vehicle starts to drive in a state in which the engine is turned off or a specific driving condition is satisfied.

The processor may operate the heating wire in a heating stage with a smallest temperature, may operate the ventilation motor in a cooling stage with a smallest rotational speed, may power off the heating wire, or may power off the ventilation motor, if the engine is temporarily turned off by the ISG function, and may activate the recent control mode, if the engine is turned on again by the ISG function.

The processor may set the last heating stage to a stage in which the heating wire of the seat is powered off, based on that the heating wire of the seat does not normally operate or may set the last cooling stage to a stage in which the ventilation motor is powered off, based on that the ventilation motor does not normally operate.

The processor may store at least one of the last heating stage or the last cooling stage, or any combination thereof in the memory, may update the last heating stage stored in the memory, whenever the heating wire is powered off, and may update the last cooling stage stored in the memory, whenever the ventilation motor is powered off.

The processor may power off both the heating wire and the ventilation motor, based on that the state of the IGN of the vehicle is deactivated.

According to another aspect of the present disclosure, a vehicle control method may include identifying, by a processor, at least one of a last heating stage which operates before a heating wire of a seat is powered off among at least two heating stages divided according to a temperature of the heating wire of the seat or a last cooling stage which operates before a ventilation motor of the seat is powered off among at least two cooling stages divided according to a rotational speed of the ventilation motor of the seat, or any combination thereof and activating, by the processor, a recent control mode for controlling the heating wire of the seat in the last heating stage or a predetermined heating stage or controlling the ventilation motor of the seat in the last cooling stage or a predetermined cooling stage, based on at least one of a state of an ignition (IGN) of a vehicle, whether a power source of the vehicle is remotely activated, or whether a battery of the vehicle is being charged, or any combination thereof.

In the vehicle control method, the activating of the recent control mode for controlling the heating wire of the seat in the last heating stage or the predetermined heating stage or controlling the ventilation motor of the seat in the last cooling stage or the predetermined cooling stage, based on the at least one of the state of the ignition (IGN) of the vehicle, whether the power source of the vehicle is remotely activated, or whether the battery of the vehicle is being charged, or the any combination thereof, by the processor may include controlling, by the processor, the heating wire of the seat in the last heating stage or the predetermined heating stage or controlling, by the processor, the ventilation motor of the seat in the last cooling stage or the predetermined cooling stage, based on that the state of the IGN of the vehicle is activated, in a state in which the state of the IGN of the vehicle is deactivated, the power source of the vehicle is not remotely activated, and the battery of the vehicle is not being charged.

In the vehicle control method, the activating of the recent control mode for controlling the heating wire of the seat in the last heating stage or the predetermined heating stage or controlling the ventilation motor of the seat in the last cooling stage or the predetermined cooling stage, based on the at least one of the state of the ignition (IGN) of the vehicle, whether the power source of the vehicle is remotely activated, or whether the battery of the vehicle is being charged, or the any combination thereof, by the processor may include failing to activate the recent control mode, based on that the heating wire of the seat or the ventilation motor of the seat is manipulated by a user, the heating wire of the seat or the ventilation motor of the seat interworks with an air conditioning system to be automatically controlled, the heating wire of the seat or the ventilation motor of the seat operates in a specific stage while the power source of the vehicle is remotely activated, or the heating wire or the ventilation motor is powered off while the power source of the vehicle is remotely activated.

In the vehicle control method, the activating of the recent control mode for controlling the heating wire of the seat in the last heating stage or the predetermined heating stage or controlling the ventilation motor of the seat in the last cooling stage or the predetermined cooling stage, based on the at least one of the state of the ignition (IGN) of the vehicle, whether the power source of the vehicle is remotely activated, or whether the battery of the vehicle is being charged, or the any combination thereof, by the processor may include correcting, by the processor, a temperature of the heating wire in the last heating stage or correcting, by the processor, a rotational speed of the ventilation motor in the last cooling stage, based on at least one of an indoor temperature of the vehicle, an outdoor temperature of the vehicle, or weather information, or any combination thereof.

In the vehicle control method, the activating of the recent control mode for controlling the heating wire of the seat in the last heating stage or the predetermined heating stage or controlling the ventilation motor of the seat in the last cooling stage or the predetermined cooling stage, based on the at least one of the state of the ignition (IGN) of the vehicle, whether the power source of the vehicle is remotely activated, or whether the battery of the vehicle is being charged, or the any combination thereof, by the processor may include correcting, by the processor, a temperature of the heating wire in the last heating stage or correcting, by the processor, a rotational speed of the ventilation motor in the last cooling stage, based on profile information including at least one of a gender of a user, an age of the user, or body information of the user, or any combination thereof.

In the vehicle control method, the correcting of the temperature of the heating wire in the last heating stage or the correcting of the rotational speed of the ventilation motor in the last cooling stage, based on the profile information including the at least one of the gender of the user, the age of the user, or the body information of the user, or the any combination thereof, by the processor may include updating, by the processor, the profile information based on that information included in the profile information is changed and correcting, by the processor, the temperature of the heating wire in the last heating stage or correcting, by the processor, the rotational speed of the ventilation motor in the last cooling stage, based on the updated profile information.

In the vehicle control method, the activating of the recent control mode for controlling the heating wire of the seat in the last heating stage or the predetermined heating stage or controlling the ventilation motor of the seat in the last cooling stage or the predetermined cooling stage, based on the at least one of the state of the ignition (IGN) of the vehicle, whether the power source of the vehicle is remotely activated, or whether the battery of the vehicle is being charged, or the any combination thereof, by the processor may include activating, by the processor, the recent control mode, based on an idle stop and go (ISG) function of temporarily turning off an engine if the vehicle stops and turning on the engine again if the vehicle starts to drive in a state in which the engine is turned off or a specific driving condition is satisfied.

In the vehicle control method, the activating of the recent control mode, based on the idle stop and go (ISG) function of temporarily turning off the engine if the vehicle stops and turning on the engine again if the vehicle starts to drive in the state in which the engine is turned off or the specific driving condition signal is satisfied, by the processor may include operating, by the processor, the heating wire in a heating stage with a smallest temperature, operating, by the processor, the ventilation motor in a cooling stage with a smallest rotational speed, powering off, by the processor, the heating wire, or powering off, by the processor, the ventilation motor, if the engine is temporarily turned off by the ISG function, and activating, by the processor, the recent control mode, if the engine is turned on again by the ISG function.

The vehicle control method may further include setting, by the processor, the last heating stage to a stage in which the heating wire of the seat is powered off, based on that the heating wire of the seat does not normally operate, or setting, by the processor, the last cooling stage to a stage in which the ventilation motor is powered off, based on that the ventilation motor does not normally operate.

The present technology may fail to operate a heating element of a seat in a last heating stage or may fail to operate a ventilation motor of the seat in a last cooling stage if a user does not ride in a vehicle, for example, if the vehicle is remotely ignition on while the user does not ride in the vehicle or charging a battery of the vehicle while the user does not ride in the vehicle, thus reducing unnecessary power consumption.

Furthermore, the present technology may correct a temperature of the heating element in the last heating stage or may correct a rotational speed of the ventilation motor in the last cooling stage, based on an indoor temperature of the vehicle, an outdoor temperature of the vehicle, weather information, and user profile information.

Furthermore, the present technology may control the heating element of the seat or the ventilation motor of the seat not to collide with an air conditioning system of the vehicle, a remote control system of the vehicle, or direct manipulation of the user, thus minimizing inconvenience of the user due to a malfunction.

Furthermore, the present technology may control the heating element of the seat or the ventilation motor of the seat, which is previously loaded into the vehicle, thus providing various users with a luxurious experience at a low cost.

In addition, various effects ascertained directly or indirectly through the present disclosure may be provided.

Hereinabove, although the present disclosure has been described with reference to one or more example embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the example embodiments disclosed in the present disclosure are not intended to limit the technical idea of the present disclosure and are intended to describe the present disclosure, and the scope of the technical idea of the present disclosure is not limited by the example embodiments. The scope of the present disclosure should be construed on the basis of the accompanying claims, and all the technical ideas within the scope equivalent to the claims should be interpreted as being included in the claims of the present disclosure.

What is claimed is:

1. A vehicle control apparatus comprising:
memory storing program instructions for controlling at least one of:
a heating element of a seat of a vehicle, or
a ventilation motor of the seat of the vehicle; and
a processor configured to execute the program instructions to:
identify a most recently used temperature setting, of a plurality of temperature settings, of the seat before the heating element or the ventilation motor was powered off, wherein each temperature setting of the plurality of temperature settings corresponds to one of: a respective temperature of the heating element or a respective rotational speed of the ventilation motor; and
based on at least one of an ignition state of the vehicle, whether a power source of the vehicle is remotely activated, or whether a battery of the vehicle is being charged, or any combination thereof, activate a control mode, most recently used in the vehicle, for controlling one of the heating element or the ventilation motor of the seat in one of: the most recently used temperature setting of the seat or a predetermined temperature setting.

2. The vehicle control apparatus of claim 1, wherein the processor is configured to execute the program instructions to activate the control mode by:
based on the ignition state of the vehicle transitioning from a deactivation state to an activation state, the power source of the vehicle not being remotely activated, and the battery of the vehicle not being charged, controlling the heating element or the ventilation motor of the seat in the most recently used temperature setting or the predetermined temperature setting.

3. The vehicle control apparatus of claim 1, wherein the processor is configured to execute the program instructions further to:
determine not to activate the control mode, based on at least one of:
the heating element or the ventilation motor of the seat being manipulated by a user,
the heating element or the ventilation motor of the seat interworking with an air conditioning system for automatic control,
the heating element or the ventilation motor of the seat operating in a specific temperature setting after the power source of the vehicle is remotely activated, or
the heating element or the ventilation motor being powered off after the power source of the vehicle is remotely activated.

4. The vehicle control apparatus of claim 1, wherein the processor is configured to execute the program instructions further to:
based on at least one of an indoor temperature of the vehicle, an outdoor temperature of the vehicle, or weather information, or any combination thereof, adjust a temperature, associated with the most recently used temperature setting, of the heating element or a rotational speed, associated with the most recently used temperature setting, of the ventilation motor.

5. The vehicle control apparatus of claim 1, wherein the processor is configured to execute the program instructions further to:
adjust, based on profile information of a user of the vehicle, a temperature, associated with the most recently used temperature setting, of the heating element or a rotational speed, associated with the most recently used temperature setting, of the ventilation motor, wherein the profile information indicates at least one of: a gender of the user, an age of the user, or body information of the user, or any combination thereof.

6. The vehicle control apparatus of claim 5, wherein the processor is configured to execute the program instructions further to:
adjust, based on the profile information being updated, the temperature, associated with the most recently used temperature setting, of the heating element or the rotational speed, associated with the most recently used temperature setting, of the ventilation motor.

7. The vehicle control apparatus of claim 1, wherein the processor is configured to execute the program instructions further to:
activate, based on an idle stop and go (ISG) function, the control mode, wherein the ISG function enables the vehicle to, after the vehicle stops, temporarily turn off an engine of the vehicle and to, after the vehicle starts moving, turn on the engine.

8. The vehicle control apparatus of claim 7, wherein the processor is configured to execute the program instructions further to:
based on the engine being temporarily turned off by the ISG function, perform at least one of:
operating the heating element in a lowest temperature setting of the plurality of temperature settings,
operating the ventilation motor in a temperature setting with a lowest rotational speed,
powering off the heating element, or
powering off the ventilation motor; and
activate, based on the engine being turned on by the ISG function after the vehicle starts moving, the control mode.

9. The vehicle control apparatus of claim 1, wherein the processor is configured to execute the program instructions further to perform one of:
setting, based on determining that the heating element of the seat is inoperable, the most recently used temperature setting to power off the heating element; or
setting, based on determining that the ventilation motor is inoperable, the most recently used temperature setting to power off the ventilation motor.

10. The vehicle control apparatus of claim 1, wherein the processor is configured to execute the program instructions further to:
store the most recently used temperature setting in the memory; and
update, based on the heating element or the ventilation motor being powered off, the most recently used temperature setting.

11. The vehicle control apparatus of claim 1, wherein the processor is configured to execute the program instructions further to:
power off, based on the ignition state of the vehicle being a deactivation state, the heating element and the ventilation motor.

12. The vehicle control apparatus of claim 1, wherein the processor is configured to execute the program instructions further to:
determine whether to engage an automatic temperature adjustment function, which, based on the heating element operating for longer than a threshold time duration, switches the temperature setting of the heating element from a first temperature setting to a second temperature setting that is lower than the first temperature setting; and
control, based on determining to engage the automatic temperature adjustment function before the heating element of the seat is powered off, the heating element of the seat to operate in the first temperature setting.

13. A method performed by an apparatus of a vehicle, the method comprising:
identifying a most recently used temperature setting, of a plurality of temperature settings, of a seat of the vehicle before a heating element of the seat or a ventilation motor of the seat was powered off, wherein each temperature setting of the plurality of temperature settings corresponds to one of: a respective temperature of the heating element or a respective rotational speed of the ventilation motor; and
based on at least one of an ignition state of the vehicle, whether a power source of the vehicle is remotely activated, or whether a battery of the vehicle is being charged, or any combination thereof, activating a control mode, most recently used in the vehicle, for controlling one of the heating element or the ventilation motor of the seat in one of: the most recently used temperature setting of the seat or a predetermined temperature setting.

14. The method of claim 13, wherein the activating of the control mode comprises:
based on the ignition state of the vehicle transitioning from a deactivation state to an activation state, the power source of the vehicle not being remotely activated, and the battery of the vehicle not being charged, controlling the heating element or the ventilation motor of the seat in the most recently used temperature setting or the predetermined temperature setting.

15. The method of claim 13, further comprising:
determining not to activate a second control mode, based on at least one of:
the heating element or the ventilation motor of the seat being manipulated by a user,
the heating element or the ventilation motor of the seat interworking with an air conditioning system for automatic control,
the heating element or the ventilation motor of the seat operating in a specific temperature setting after the power source of the vehicle is remotely activated, or
the heating element or the ventilation motor being powered off after the power source of the vehicle is remotely activated.

16. The method of claim 13, further comprising:
based on at least one of an indoor temperature of the vehicle, an outdoor temperature of the vehicle, or weather information, or any combination thereof, adjusting a temperature, associated with the most recently used temperature setting, of the heating element or a rotational speed, associated with the most recently used temperature setting, of the ventilation motor.

17. The method of claim 13, further comprising:
adjusting, based on profile information of a user of the vehicle, a temperature, associated with the most recently used temperature setting, of the heating element or a rotational speed, associated with the most recently used temperature setting, of the ventilation motor, wherein the profile information indicates at least one of: a gender of the user, an age of the user, or body information of the user, or any combination thereof.

18. The method of claim 17, further comprising:
adjusting, based on the profile information being updated, the temperature, associated with the most recently used temperature setting, of the heating element or the rotational speed, associated with the most recently used temperature setting, of the ventilation motor.

19. The method of claim 13, further comprising:
activating, based on an idle stop and go (ISG) function, the control mode, wherein the ISG function enables the vehicle to, after the vehicle stops, temporarily turn off an engine of the vehicle and to, after the vehicle starts moving, turn on the engine.

20. The method of claim 19, further comprising:
based on the engine being temporarily turned off by the ISG function, perform at least one of:
operating the heating element in a lowest temperature setting of the plurality of temperature settings,
operating the ventilation motor in a temperature setting with a lowest rotational speed,
powering off the heating element, or
powering off the ventilation motor; and
activating, based on the engine being turned on by the ISG function after the vehicle starts moving, the control mode.
